(19) United States
(12) Patent Application Publication
(10) Pub. No.: US 2007/0069839 A1
(43) Pub. Date: Mar. 29, 2007

(54) Device for coupling suspended stripline and NRD guides

(75) Inventors: Nagendra Prasad Pathak, New Delhi (IN); Shiban Kishen Koul, New Delhi (IN); Ananjan Basu, New Delhi (IN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Indian Institute of Technology, Delhi, New Delhi (IN)

(21) Appl. No.: 11/239,489

(22) Filed: Sep. 29, 2005

(51) Int. Cl. H01P 3/12

(52) U.S. Cl. 333/239; 333/248

(57) ABSTRACT

A hybrid microwave-coupling device for transmitting signals from non-radiative dielectric (NRD) waveguides to suspended striplines (SSL) or vice-versa. The two transmission lines are placed transversally with longitudinal side of the NRD guide facing the SSL for conversion of particular transverse electromagnetic (TEM) mode to Longitudinal Section Magnetic Mode (LSM).

### FIELD OF THE INVENTION

The invention relates to an improved device for coupling suspended stripline and NRD guides.

### BACKGROUND OF THE INVENTION

Nonradiative dielectric (NRD) guide and suspended stripline (SSL) are two prominent transmission media for realizing millimeter wave integrated circuits. The low loss and low production cost are two main factors that make NRD guide suitable for wireless communication applications at millimeter wave frequencies. On the other hand, suspended stripline overcomes the disadvantage of having to maintain tight dimensional tolerances as in rectangular waveguide and incorporates the advantageous features of planar technology in the millimeter wave region. The circuits are compatible with beam lead and chip devices, thus offer potential for construction of passive and active millimeter wave integrated circuits. Furthermore, suspended stripline permits easy transition to standard rectangular waveguide and other planar and quasi-planar transmission lines. These include the inverted microstrip, finline and coplanar lines. To utilize the inherent advantages of these two prominent millimeter wave integrated circuit technologies, it is necessary to develop a suitable transition between these two transmission media.

Several transition devices have been described for coupling an NRD guide to a stripline. The concept of probe type transition between stripline and NRD guide was first proposed in 1990 in a paper titled “Analysis and Design of Strip Line to NRD Guide Transition” in Asia-Pacific Microwave Conference Proceedings. Other successful efforts to integrate NRD guide with planar transmission lines, such as, microstrip line, coplanar line or slot line have been reported in 1996. In these reported works, a transition from microstrip to NRD guide is proposed and some active and passive components useful for developing hybrid NRD guide systems are reported. However, these papers do not describe transition from NRD guide to suspended stripline.

WO 02/067366A1 describes a transition from SMA connector to NRD guide. Modified SMA connectors are available in the market for connecting SSL to the SMA connectors. However, such transitions provide very poor performance in terms of repeatability of the transmission coefficient. The higher-performance K-connector is not so suitable as it has an impact on the low-cost nature of NRD-guide components. Also, depending on the tolerances held during manufacturing, SMA connectors have a upper frequency limit which is anywhere from 18 to 26 GHz. This is highly undesirable for microwave communication applications using signals of frequencies higher than 18 GHz. In the patent, a feed line is inserted between the NRD guide and the SMA connector to transmit TEM waves and a mode suppressor is added in the middle of a bisected NRD guide for suppressing undesirable modes. This leads to additional hardware requirements in the coupling device, as an SMA connector, a feed line and a mode suppressor are required.

U.S. Pat. No. 5,987,315 describes a diode circuit in dielectric waveguide device, and detector and mixer using the diode circuit. The patent describes a diode circuit in the dielectric waveguide designed to improve the facility with which a circuit substrate is mounted in the dielectric waveguide, to make matching between a dielectric waveguide and a diode easier. A conductor pattern (forming a stripline) is disposed so as to intersect a pair of dielectric strips substantially perpendicularly to the same, and two filter circuits are fabricated on opposite sides of the dielectric strips, thereby forming a resonance circuit. However, the device described in the patent is used specifically for diode devices and requires suspending conductor pattern on a circuit substrate between conductor plates by passing the circuit substrate through the dielectric strip to form a suspended stripline. The device does not provide proper protection for the circuit substrate, which is left suspended through the dielectric strip. Also, the device requires extra filters on opposite ends and extra diodes to prevent propagation of undesirable electromagnetic wave modes through the suspended stripline. Hence extra hardware is required. The device also does not provide proper protection against external electromagnetic wave sources.

Hence there is a need for an improved coupling device, which may transmit signals from an NRD guide to a suspended stripline and vice-versa. There is also need for a coupling device, which does not require additional circuitry/devices for propagation of desired Transverse Electromagnetic mode (TEM) through the device. Also, there is a need for a coupling device, which provides protection against external electromagnetic wave sources.

### SUMMARY OF THE INVENTION

To obviate the drawbacks of the prior art the object of the instant invention is to provide an improved device for coupling suspended stripline and NRD guides.

Another object of the instant invention is to provide a coupling device that does not require additional protection circuitry for undesired TEM propagation.

Yet another object of the instant invention is to provide a coupling device that provides protection against external electromagnetic wave sources.

To achieve the aforesaid objects the instant invention provides an improved device for coupling suspended stripline and NRD guides comprising:
parallelly placed top and bottom conductor plates;
at least one dielectric strip disposed between said top and bottom conductor plates to form one or more non radiative dielectric (NRD) waveguides;
at least one conductor strip suspended between said top and bottom conductor plates to form one or more suspended striplines;
   characterized in that:
each said suspended stripline is transversally located with respect to the longitudinal side of each said non radiative dielectric waveguide at a predetermined distance for coupling energy between said non radiative dielectric waveguide and said suspended stripline; and
at least one of said dielectric strips or said suspended striplines coupling to signals from external transmission media.

### BRIEF DESCRIPTION OF THE DRAWINGS

The present invention will now be described with the help of accompanying drawings:

FIG. 1 illustrates the Dominant Mode Field Configuration of (a) Suspended Stripline and (b) NRD Guide

FIG. 2 illustrates the geometry for an embodiment of SSL-NRD-SSL transitions in accordance with the instant invention.

FIG. 3 illustrates the dimensions of Metal Housing used in SSL-NRD-SSL coupler (all dimensions are in mm) in accordance with the instant invention.

FIG. 4 illustrates the geometry for an embodiment of NRD-SSL-NRD transition in accordance with the instant invention.

FIG. 5 illustrates the dimensions of Metal Housing used in NRD-SSL-NRD coupler (all dimensions are in mm) in accordance with the instant invention.

FIG. 6 illustrates the measured and simulated characteristics of SSL-NRD-SSL transition in accordance with the instant invention.

FIG. 7 illustrates measured characteristics of SSL-NRD-SSL transition for two different SSL probe shapes in accordance with the instant invention.

FIG. 8 illustrates the measured and simulated characteristics of NRD-SSL-NRD transition in accordance with the instant invention.

### DETAILED DESCRIPTION OF THE PREFERRED EMBODIMENT

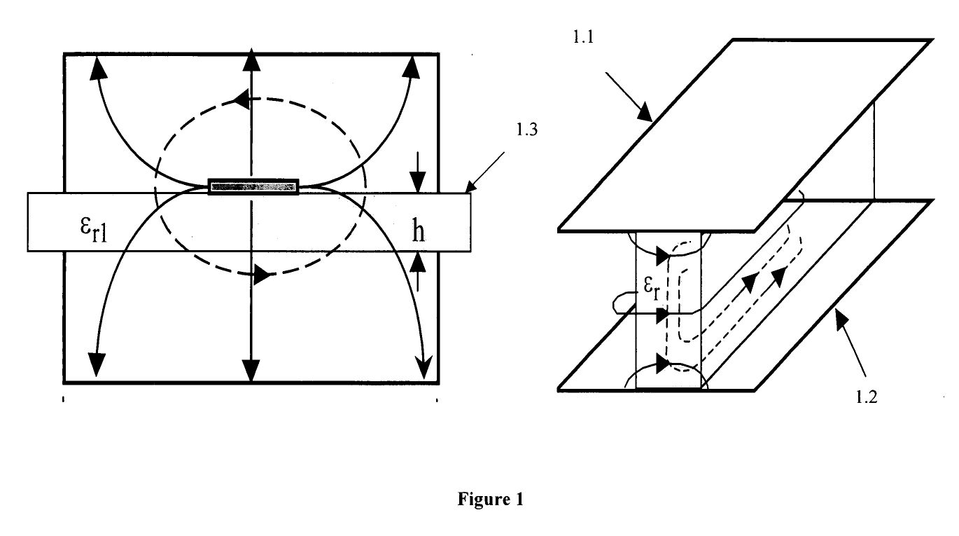

FIG. 1 shows the cross-sectional view of the suspended stripline and longitudinal view of the NRD guide along with the electric and magnetic field distributions for the desired modes. The suspended stripline supports a Quasi-TEM mode whose field distribution (H is dotted) is shown in FIG. 1(a). NRD guide supports two modes viz. LSE₁₁ and LSM₁₁. The LSM₁₁ mode is desirable, loss-less mode and its electric field is parallel to the metal plates (1.1 and 1.2) while magnetic field lines are parallel to the dielectric-air interface (1.3) as shown in FIG. 1(b). On careful examination of the field configurations of these two structures, it is observed that if front side of SSL is placed on the longitudinal side of NRD guide, its magnetic field lines are parallel to the magnetic field lines of the NRD guide. Thus, if properly aligned, it is possible to couple electromagnetic energy from quasi-TEM mode of SSL to LSM₁₁ mode of NRD guide. This field-matching concept has been used to design this new hybrid transition. Coupling of energy depends on several parameters such as the relative positions of the open ends of NRD guide and SSL, dielectric constant of SSL substrate, probe shape, etc.

In the preferred embodiment, the coupling from NRD guide to suspended stripline can be developed using a probe type structure. Two possible ways of realizing a back-to-back NRD guide to suspended stripline transition for testing, a back-to-back transition, as opposed to a single one, is required) are described where: (a) suspended stripline probe is located at the input and output side of the NRD guide, and (b) NRD guide is located at the input and output side of the suspended stripline. The coupling structure developed using first topology is named as SSL-NRD-SSL coupler. The coupling structure developed using the second topology is named as NRD-SSL-NRD coupler. Hence, depending on the application and external transmission media, a coupling device can be fabricated for case (a) or case (b). These two differ only in the way they are connected to the external media, and not in the behaviour of the actual SSL-NRD transitions.

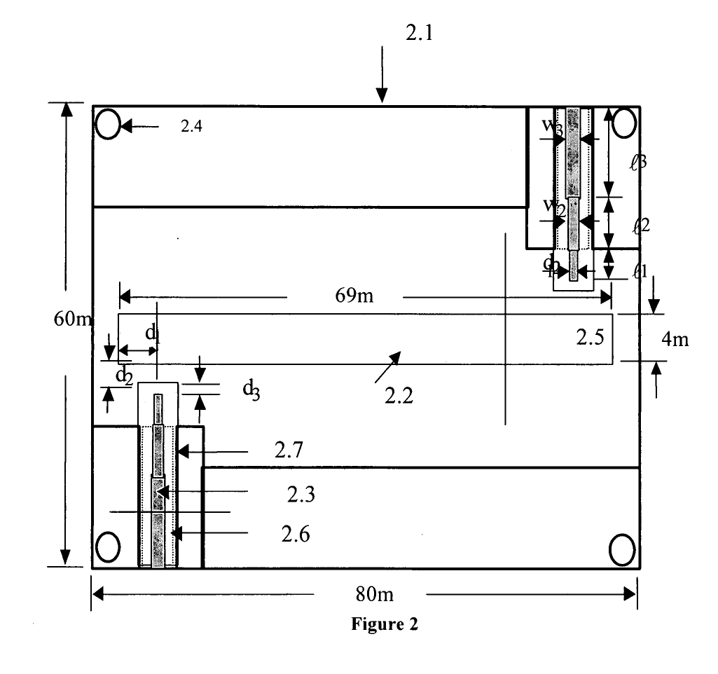

FIG. 2 shows the geometry of SSL-NRD-SSL coupler. The coupling device comprises two metal plates (2.1), a dielectric (Teflon) strip (2.2) and a SSL probe (2.3). The two metal plates (2.1) are designed so as to form an enclosure/housing for the dielectric strip (2.2), the SSL probes (2.3) and threaded holes (2.4). A channel (2.5) is machined in the bottom and top ground metal plates of the housing to accommodate each dielectric strip (2.2) and the SSL probes (2.3). The channel for the dielectric strip (2.5) is created so as to be essentially parallel to the edges of the housing and the channels for SSL probes (2.6) are created essentially perpendicular to the dielectric strip channel (2.5). Additionally, the SSL probe channels (2.6) are made so as to be facing the longitudinal side of the dielectric strip channel (2.5) at an optimized distance d₁ between the center of the SSL probe (2.3) and edge of the NRD guide (2.2). Similarly, a distance d₂ between the SSL probe (2.3) and side of the NRD guide (2.2) is optimized to minimize the insertion loss between the two media. The distance d₃ between the edge of the dielectric substrate (2.7) of the probe and the edge of SSL strip conductor of the probe is also optimized for the same purpose. Besides this, probe (2.6) dimensions (l₁, l₂, w₁, w₂, w₃ and l₃) are optimized for minimizing insertion loss. Threaded holes are used for inserting screws for attaching the two metal plates for forming an housing.

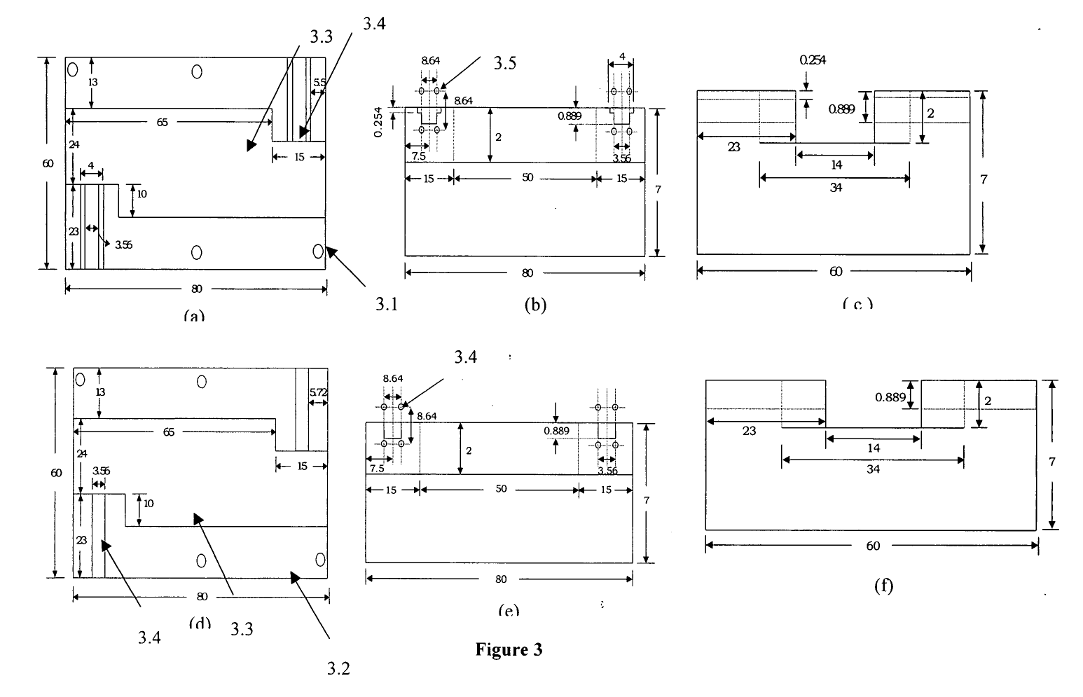

The metal housing used in the design of this transition is shown in FIG. 3 along with the dimensions used in the present embodiment. The housing comprises two metal plates (3.1 and 3.2) with channels for dielectric strips (3.3) and conductor strips (3.4) precisely located to form enclosures for forming suspended striplines and NRD guides, threaded holes (3.6) and screws for the threaded holes (3.6). A two-level channel (3.5) is machined for the stripline probe channel in the bottom metal plate (3.1). The upper level channel of the two-level channel (3.5) is used to place the thin RT-duroid substrate carrying the printed probe and the lower level channel of the two-level channel (3.5) forms the bottom air-gap for the suspended stripline. Creating the channel in the top metal plate (3.2) for stripline probe channel (3.3) is easy as it requires machining a single channel in the metal plate (3.2) and it does not pose any complexity to the geometry of the NRD guide. The channels in the top and bottom plates (3.1 and 3.2) for NRD guide are placed precisely to form a single channel holding the dielectric strip in side grooves. The dimensions of the metal housing including channels are optimized using a Finite Element Method (FEM) simulator. In the preferred embodiment, the dimensions of the SSL channels (3.3) are selected so that cut-off frequencies of higher order modes are much above the operating frequency, and it supports only Quasi TEM mode of propagation. The dimensions are selected according to the cutoff frequency formula available in literature. The Teflon NRD guide used in the transition directs energy from the input port to the output port. The threaded holes (3.6) and the screws are used to attach the top and bottom plates (3.1 and 3.2) to form a single housing.

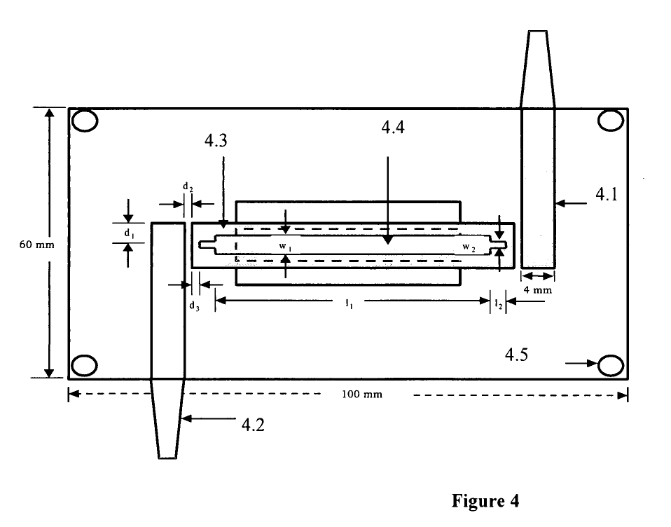

The dual geometry of the second embodiment with the NRD-SSL-NRD coupler is shown in FIG. 4. NRD guides (4.1) are used at the input and output ports for connecting the device to external transmission media using tapered transitions (4.2) and a single suspended stripline (4.3) is used in the middle for coupling energy from input to output NRD guides. Different patterns may be used in the SSL conductor strip (4.4) to form different microwave circuits and hence the device may be used for forming microwave circuitry harder to realize using simple NRD guide based microwave circuits. Threaded holes (4.5) are provided for attaching the metal plates to form the housing.

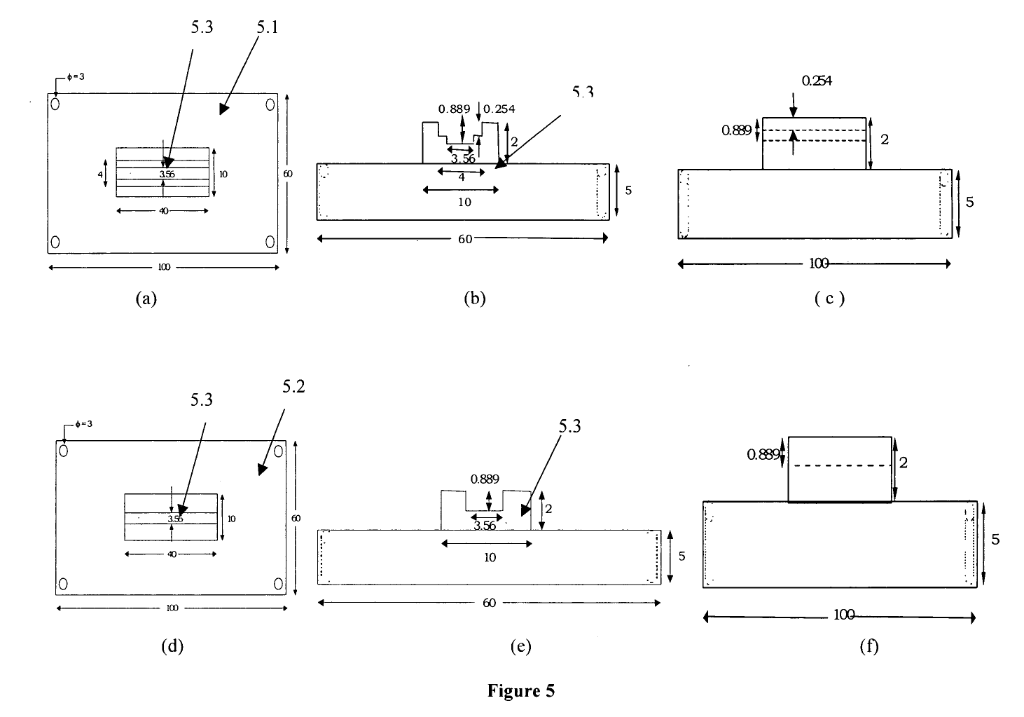

The drawing of the metal housing used in the development of this coupler along with its dimensions is given in FIG. 5. A channel (5.3) is created in the ground plates (5.1 and 5.2) parallel to the edges to accommodate the suspended stripline. Channels for input and output lines are for NRD guides that are extended so that the longitudinal side of the NRD guides is essentially perpendicular to the front of the SSL. Two-level channel (5.3) is formed in the bottom plate (5.1) similar to the channel in first embodiment. The distances d₁, d₂ and d₃ are optimized to minimize the insertion loss and to allow quasi TEM mode of propagation. The physical dimensions of the final optimized coupler are: bottom metal plate (80 mm×60 mm×7 mm), top metal plate (80 mm×60 mm×7 mm), SSL channel (23 mm×3.56 mm×1.78 mm), Teflon strip (70.0 mm×4 mm×4 mm), RT-duroid (27.9 mm×4 mm×0.254 mm), stepped impedance probe (l₁=19.0 mm, w₁=2.0 mm, l₂=6.3 mm, w₂=1.5 mm, l₃=2.55 mm, w₃=1.0 mm), 50 ohm line probe (l=27.9 mm, w=2.0 mm) , d₁=2.0 mm, d₂=0.1 mm, d₃=0.05 mm.).

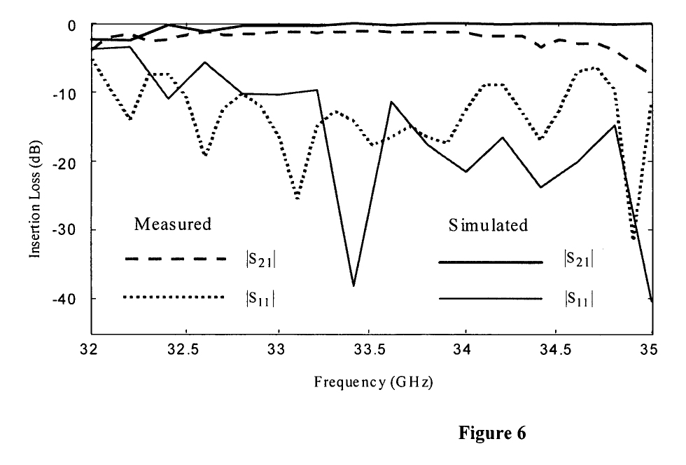

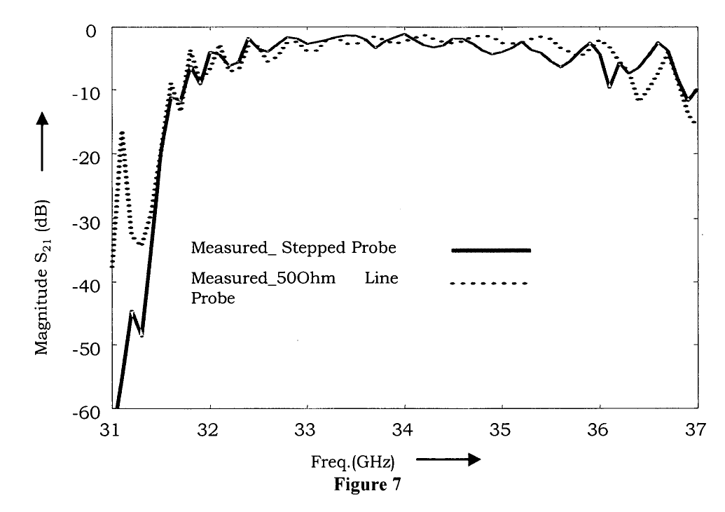

FIG. 6 shows the measured response of the back-to-back SSL-NRD-SSL coupler. The simulated response is superimposed on this plot for comparison. Good agreement is observed between simulated and experimental results. It is evident that the measured bandwidth is smaller than the simulated values. The reason for this is the fact that two extra transitions from SSL to K-connector, used for testing at either end, are not considered in the simulation. Flat response of the K-connector transition at frequencies above 35 GHz is difficult to achieve. Due to this reason, the overall measured transmission loss of the transition assembly increases significantly above 35 GHz. FIG. 7 shows the measured response of the transition for two different SSL probe shapes. The response is practically identical although simulations predict that a slight improvement with stepped probe is possible.

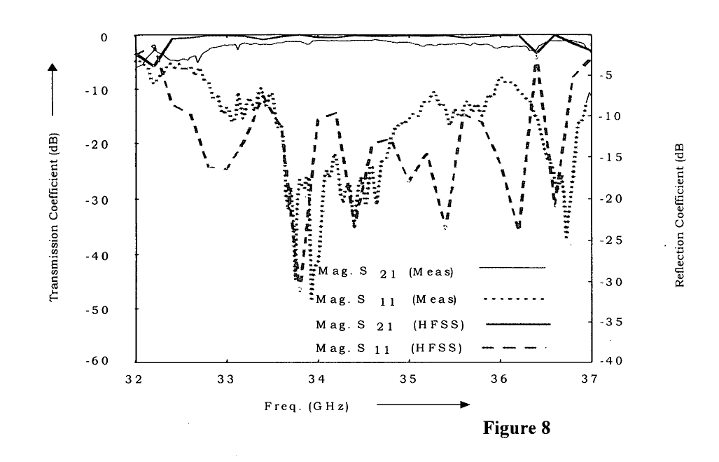

The problem of increased measured loss at higher frequency end in SSL-NRD-SSL coupler can be taken care of by using the dual geometry i.e. NRD-SSL-NRD coupler. Since rectangular wave-guide to NRD guide tapered transition (used for test purposes) works fairly well from 32 GHz onwards, the problem of bandwidth contraction is not observed while making measurements. Keeping this in mind, the WG-NRD-SSL-NRD-WG transition is simulated. The optimized probe (in principle this should be same as the first type) is of stepped impedance type, which gives low insertion loss over a wide bandwidth. The dimensions used in the fabrication of this transition structure are: Bottom metal plate (100 mm×60 mm×5 mm), Top metal plate (100 mm×60 mm×5 mm), SSL Channel (40 mm×3.56 mm×1.78 mm), Substrate (RT-duroid, h=0.254 mm, εᵣ=2.22), Probe dimensions (l₁=46.9 mm, l₂=1.5 mm, w₁=2.5 mm, w₂=1.5 mm, l₃=0.05 mm) and strip to probe spacing (d₂=0.1 mm, d₁=2.0 mm). The measured and simulated insertion loss of this coupler is shown in FIG. 8. As observed, this dual coupling structure offers a sufficiently wide bandwidth (4 GHz) with low insertion loss.

All documents cited in the description are incorporated herein by reference. The present invention is not to be limited in scope by the specific embodiments and examples which are intended as illustrations of a number of aspects of the invention and any embodiments which are functionally equivalent are within the scope of this invention. Those skilled in the art will know, or be able to ascertain using no more than routine experimentation, many equivalents to the specific embodiments of the invention described herein. These and all other equivalents are intended to be encompassed by the following claims.

We claim:

1. An improved device for coupling suspended stripline and NRD guides comprising:
parallely placed top and bottom conductor plates;
at least one dielectric strip disposed between said top and bottom conductor plates to form one or more non radiative dielectric (NRD) waveguides;
at least one conductor strip suspended between said top and bottom conductor plates to form one or more suspended striplines;
characterized in that:
each said suspended stripline is transversally located with respect to the longitudinal side of each said non radiative dielectric waveguide at a predetermined distance for coupling energy between said non radiative dielectric waveguide and said suspended stripline; and
at least one of said dielectric strips or said suspended striplines coupling to signals from external transmission media.

2. An improved device for coupling suspended stripline and NRD guides as claimed in claim 1, wherein said top and bottom conductor plates are joined to form a conductor housing.

3. An improved device for coupling suspended stripline and NRD guides as claimed in claim 2, wherein said conductor housing comprising:
said top conductor plate and said bottom conductor plate;
a plurality of holes located in same location on said top and said bottom conductor plates;
a plurality of fasteners each placed in said hole for attaching said top and said bottom conductor plates to form an enclosure in said conductor housing;
a stripline channel inside said conductor housing on said bottom conductor plate and said top conductor plate for suspending each said suspended stripline; and
a dielectric channel inside said conductor housing on said bottom conductor plate and said top conductor plate for each said non radiative dielectric waveguide.

4. An improved device for coupling suspended stripline and NRD guides as claimed in claim 3, wherein part of each said stripline channel in said bottom conductor plate conductor plate comprising:
a upper level channel machined in said bottom conductor plate for holding said suspended stripline; and
a lower level channel machined in said upper level channel for realizing an bottom air-gap of the suspended stripline and inserting a dielectric substrate.

5. An improved device for coupling suspended stripline and NRD guides as claimed in claim 3, wherein part of each said stripline channel in said top conductor plate comprising:
a channel machined on said top conductor plate; and
said channel located precisely above part of said stripline channel on said bottom conductor plate for forming an upper air-gap of said stripline channel.

6. An improved device for coupling suspended stripline and NRD guides as claimed in claim 3, wherein part of each said dielectric channel in said top conductor plate and said bottom conductor plate comprising channels machined in said bottom and said top conductor plates are precisely located to form said dielectric channel.

7. An improved device for coupling suspended stripline and NRD guides as claimed in claim 1, wherein said conductor is a metal.

8. An improved device for coupling suspended stripline and NRD guides as claimed in claim 1, wherein said dielectric strip is a Teflon strip.

9. An improved device for coupling suspended stripline and NRD guides as claimed in claim 3, wherein said dielectric substrate is made in RT-duriod substrate.

10. An improved device for coupling suspended stripline and NRD guides as claimed in claim 1, wherein said dielectric strip is placed at said predetermined distance from said suspended stripline for minimizing insertion loss.

11. An improved device for coupling suspended stripline and NRD guides as claimed in claim 1, wherein dimensions of said dielectric and stripline channels are optimized to minimize the insertion loss.

12. An improved device for coupling suspended stripline and NRD guides as claimed in claim 3, wherein dimensions of the dielectric and stripline channels are selected so that cut-off frequencies of higher order modes are much above the operating frequency of the coupling device.

13. An improved device for coupling suspended stripline and NRD guides as claimed in claim 3, dimensions of the dielectric and stripline channels are selected to ensure support of quasi TEM mode of propagation.

14. An improved device for coupling suspended stripline and NRD guides as claimed in claim 13, wherein said selection of dimensions for said dielectric and stripline channels are made by means of a Finite Element Method based simulator.

15. An improved device for coupling suspended stripline and NRD guides as claimed in claim 1, wherein said non radiative dielectric strips are coupled to signals from said external transmission media by means of a tapered transition.

16. An improved device for coupling suspended stripline and NRD guides as claimed in claim 1, wherein said suspended striplines are coupled to signals from said external transmission media by means of co-axial connectors.

17. An improved device for coupling suspended stripline and NRD guides as claimed in claim 1, wherein the coupling is by means of stepped impedance type probe in the suspended stripline.
